(19) United States
(12) Patent Application Publication
(10) Pub. No.: US 2014/0102435 A1
(43) Pub. Date: Apr. 17, 2014

(54) Oxygen Activated Portable Heater With Electrolyte Pad

(71) Applicant: Rechargeable Battery Corporation, College Station, TX (US)

(72) Inventors: Charles Sesock, College Station, TX (US); Christopher Pedicini, Nashville, TN (US); Adam Laubach, Kingwood, TX (US); Darko Marquez, College Station, TX (US); E. William Cowell, Corvallis, OR (US)

(21) Appl. No.: 14/055,250

(22) Filed: Oct. 16, 2013

Related U.S. Application Data
(60) Provisional application No. 61/714,526, filed on Oct. 16, 2012.

(51) Int. Cl. F24J 1/00; B23P 19/00; C09K 5/18

(52) U.S. Cl. CPC F24J 1/00; C09K 5/18; B23P 19/00
USPC 126/263.02; 29/428

(57) ABSTRACT

An oxygen based heater including a heater substrate and a pad impregnated with an electrolyte solution disposed adjacent to the heater substrate which transfers electrolyte to the heater substrate. Methods of manufacturing same in an oxygen containing environment in which electrolyte is impregnated onto pad which is adjacent heater substrate.

### CROSS REFERENCE TO RELATED APPLICATIONS

This application claims priority to U.S. Provisional Application Ser. No. 61/714,526 filed on Oct. 16, 2012, the entirety of which is incorporated herein.

### FIELD OF THE INVENTION

The invention relates to a heater that uses atmospheric oxygen as a fuel source for a reaction that produces heat, and more specifically such a heater that also includes a pad impregnated with an electrolyte solution.

### BACKGROUND OF THE INVENTION

Portable flameless heaters are currently used in a variety of applications, such as heating comestible and other consumer products.

With respect to heating comestible items, the United States Army uses a flameless ration heater (“FRH”) rather than a portable camp stove to heat a pre-packaged meal ready to eat (“MRE”) eight-ounce (approximately 227 grams) field ration. The FRH consists of a super-corroding magnesium/iron mixture sealed in a waterproof pouch (total FRH weight is approximately 22 grams). To operate a FRH, the pouch is opened into which the MRE is inserted, and approximately 58 grams of water is added to a fuel-containing portion of the FRH pouch surrounding the MRE to initiate the following reaction:

Mg+2H₂O→Mg(OH)₂+H₂

Based upon the above reaction of the fuel, the MRE temperature is raised by approximately 100° F. in less than 10 minutes. The maximum temperature of the system is safely regulated to about 212° F. by evaporation and condensation of water vapor.

The current FRH, while effective for its intended purpose, produces hydrogen gas as a byproduct, generating safety, transportation, storage and disposal concerns, and making it less suitable for use in consumer sector applications where accidental misuse could lead to fire or explosion.

Also, the water required for reaction, in addition to being heavy and spacious, is typically obtained from a supply of drinking water, which can be limited. Further, the step of adding the water can also be an inconvenient additional step in the process of activating the FRH.

Self-heating food packaging products are also available in the consumer market. These products use the heat of hydration from mixing “quicklime” (calcium oxide) and water which does not generate hydrogen (CaO+H₂O→Ca(OH)₂). With water present the peak temperature is similarly limited to 212° F. However, even neglecting the weight of packaging and water, the specific energy of the system is low (approximately 1.2 kJ per gram of CaO).

These and other self-contained systems must also provide some means of mixing the segregated reactants adding further complexity and bulk. Measurements on some commercial self-heating packaged food products are shown in Table 1.

TABLE 1

| | Food product (net) | | Total package (gross) | | Specific |
|---|---|---|---|---|---|
| | Weight | Volume | Weight | Volume | energy of |
| | (g) | (ml) | (g) | (ml) | heater (kJ/g) |
| Coffee | 300 | 295 | 551 | 600 | 0.34 |
| Beef stew | 425 | 481 | 883 | 963 | 0.13 |

While quicklime based heaters may offer greater safety than the magnesium based heaters, as previously mentioned, quicklime heaters have significantly lower specific energy. Further, an increase in the weight and size of the heater (needed to compensate for the low specific energy) causes the heater to approach the size and weight of the object being heated. This reduces portability of such heaters.

In addition to the water-based heaters described above, it is known to utilize oxygen-based heaters. Oxygen-based heaters, such as those described in U.S. Pat. Nos. 5,984,995, 5,918,590 and 4,205,957, have certain benefits over water-based heaters.

First, oxygen-based heaters do not require the addition of water to generate heat. Thus, the use of same does not require a user to have any water.

Second, since oxygen-based heaters generate heat only in the presence of oxygen, the exothermic reaction can be stopped by simply preventing oxygen access. Therefore, a single heater can be reused multiple times.

Furthermore, since oxygen is abundant in the atmosphere, these heaters do not require mixing of components or elaborate systems to separate active components.

The assignee of the present invention has provided oxygen-base heaters and various packages for same. See, e.g., U.S. patent application Ser. Nos. 12/376,927 and 12/874,338 (filed on Feb. 9, 2009 and Sep. 2, 2010, respectively) both of which are incorporated herein by reference in their entirety; see also, U.S. patent application Ser. Nos. 11/486,400 and 12/711,963 (filed on Jul. 12, 2006 and Feb. 24, 2010, respectively) both of which are incorporated herein by reference in their entirety. These disclosed heaters and packages are successful at providing an oxygen based heater and/or package for same.

However, there are benefits that can be obtained from improving such heaters and packages. These benefits can provide for more efficient heaters, better packaging, easier manufacturing, and lower manufacturing costs.

The present invention is directed to providing improvements to these types of heaters to achieve these, as well as other, benefits.

### SUMMARY OF THE INVENTION

In one aspect of the present invention, the present invention is directed towards an oxygen based heater that includes a pad that has been impregnated with an electrolyte solution.

In another aspect of the present invention, the present invention is directed towards a method of manufacturing a heater that includes a pad that has an electrolyte solution.

With respect to benefits from the manufacturing methods for these heater disclosed herein, the present invention provides numerous benefits for the production of such heaters. For example, it is believed that using the pad can decrease the amount of time needed for production as it is believed to be easier and faster to apply the electrolyte solution to the pad (as opposed to the heater substrate). Furthermore, utilizing the pad will allow such heaters to be produced in an oxygen containing atmosphere, as the pad acts to minimize the amount of oxygen that reaches the heater during assembly. Additionally, utilizing such a pad will provide a more consistent and even transfer of electrolyte to the heater—resulting in a more efficient heater.

In regards to the benefits to the heater, it is believed that providing the electrolyte on the pad has numerous benefits for such a heater. For example, the pad can act as a reservoir to hold back some electrolyte until it is needed. Further, after the electrolyte solution has been transferred from the pad to the heater, the pad may act as an oxygen diffuser. In addition, the pad may provide structural integrity to the heater.

It is to be understood that the aspects and embodiments of the present invention described above may be combinable and that other advantages and aspects of the present invention will become apparent to those having ordinary skill in the art upon reading the following description of the drawing and the detailed description thereof.

### BRIEF DESCRIPTION OF THE DRAWINGS

The present invention will become more fully apparent from the following description and appended claims, taken in conjunction with the accompanying drawings. Understanding that the accompanying drawings depict only typical embodiments, and are, therefore, not to be considered to be limiting of the scope of the present disclosure, the embodiments will be described and explained with specificity and detail in reference to the accompanying drawings as provided below.

FIG. 1 is an elevated front view of the oxygen based heater in a package with a seal in an open position.

FIG. 2 is an exploded cut away view of the oxygen based heater of FIG. 1 along line A in which the removable seal of the package is in a closed position.

FIG. 3 is an exploded, elevated perspective view of another oxygen based heater in another package.

FIG. 4 is a comparative graph showing the temperature over time of two different heaters according to the present invention.

FIG. 5 is a side view of a heater according to an embodiment of the present invention.

### DETAILED DESCRIPTION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

Reference throughout this description to features, advantages, objects or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, any discussion of the features and advantages, and similar language, throughout this specification may, but does not necessarily, refer to the same embodiment.

In reference to FIGS. 1-3, heater 10 generally includes heater substrate 12, pad 14, and package 16.

Heater substrate 12 produces heat in the presence of oxygen (preferably atmospheric oxygen). A typical heater substrate 12 is comprised of a reducing agent, such as aluminum or zinc, and a binding agent, such as polytetrafluoroethylene or a polyolefin. One of ordinary skill in the art will appreciate that other chemicals can be used or included to make heater substrate 12. The term “substrate” means that heater substrate 12 is a solid object, and not merely a mass of powdered chemicals.

In order to produce a sustained exothermic reaction in the presence of oxygen, these types of heaters 10 require an electrolyte. In embodiments of the present invention, an electrolyte solution is impregnated on pad 14. Pad 14 absorbs electrolyte in the manufacturing process and evenly transfers the electrolyte to heater substrate 12. Preferred electrolytes include potassium hydroxide, potassium bromide, and potassium chloride. Other electrolytes are also contemplated.

It is contemplated that pad 14 is a non-woven material such as a blend of polyester and cellulose fibers, polypropylene fibers, or other suitable non-woven polymeric material. For example, PPAS-14 separator paper (synthetic fiber made from acrylic fiber) may be used as a pad material; however, it can be expensive. Another suitable material is a mixture of cellulose (55%) and polyester (45%) such as the material commercially known as BluSorb®. Yet another suitable material is a mixture of cellulose and cotton, such as the material commercially known as Bro-Tex®.

The type of material for pad 14 depends on the type of electrolyte used and/or the manufacturing steps/methods utilized. For example, while PPAS-14 separator paper will function a basic electrolyte solution (such as KOH); the blends of materials which contain cellulose will not operate with such an electrolyte solution. Furthermore, if the heater (with pad) is subject to processing/heating it is believed that a mixture of cellulose and cotton would not deform and thus would be more desirable than a mixture of cellulose and polyester (which may deform under processing temperatures). It is believed that one of ordinary skill in the art will appreciate that various materials may be used so long as the material is capable of absorbing and transferring (actively or passively) an electrolyte solution to heater substrate 12.

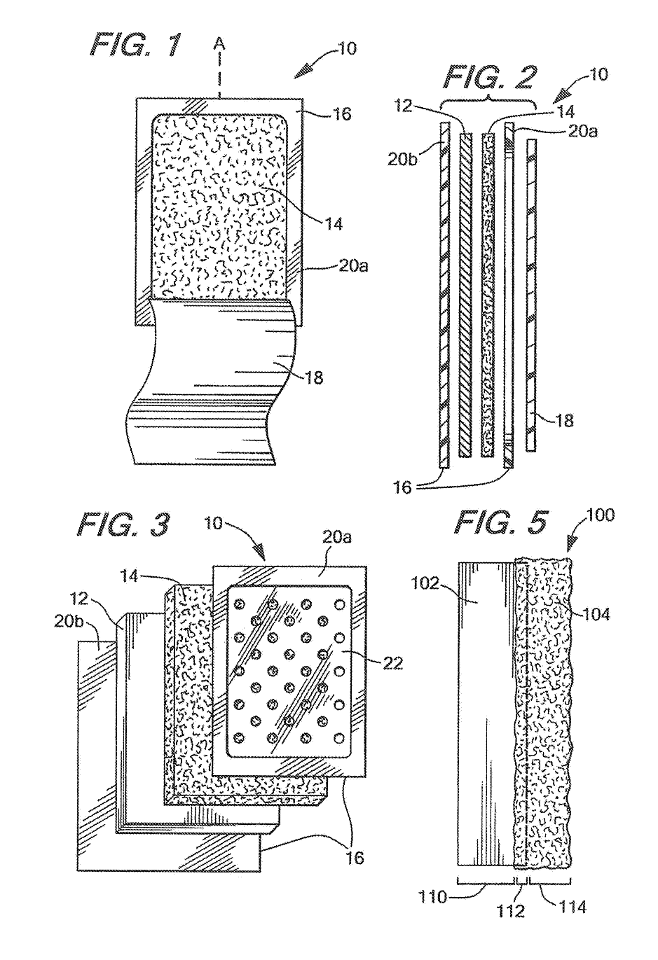

Returning back to heater 10 and FIGS. 1-3, heater substrate 12 and pad 14 are typically placed in package 16 adjacent to each other and in contact. As shown in FIGS. 2 and 3, one such preferred package 16 comprises two sheets 20a, 20b which are sealed around heater substrate 12 and pad 14. It is also preferred that package 16 includes removable seal 18 provided on at least one side 20a, 20b of package 16. In FIG. 1, removable seal 18 has been peeled off and is in an open position. In FIG. 2, removable seal 18 is shown in a closed position. In FIG. 3, removable seal 18 has been completely removed from package 16 and is not depicted.

Since the reaction is driven by the presence of oxygen, it is contemplated that removable seal 18 be capable of being re-attached to package 16 to cutoff oxygen access and stop the production of heat. As previously mentioned, the reaction (and heat production) can be started again by merely once again removing seal 18, allowing oxygen to enter package 16 and react with reducing agent in heater substrate 12.

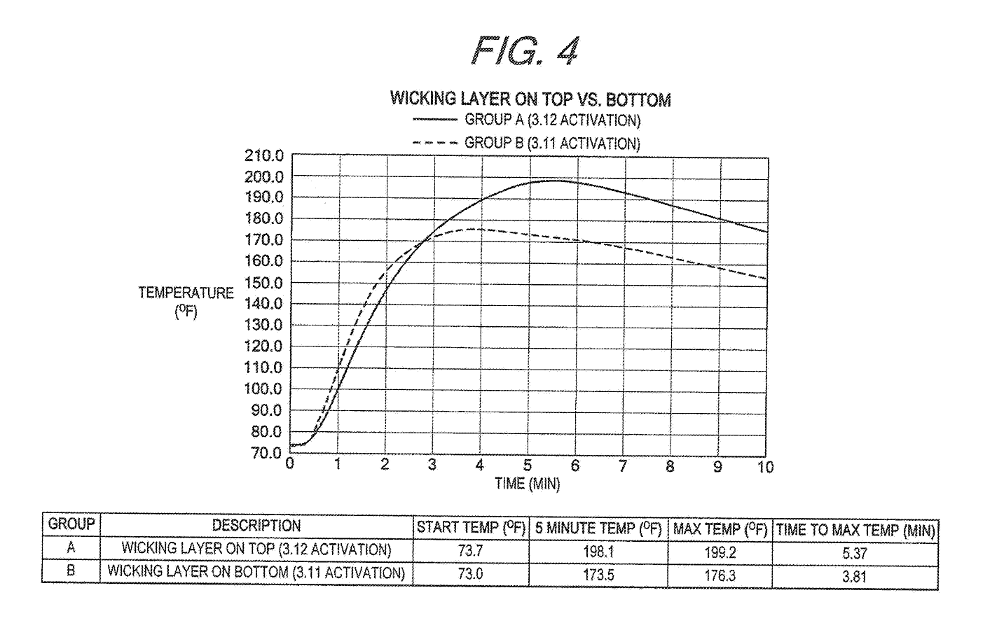

Moreover, as shown in FIG. 4, it has been found that positioning pad 14 on the side of heater substrate 12 that is adjacent removable seal 18 will provide a heater that achieves a higher maximum temperature when compared to a heater wherein pad 14 is on the side of the heater opposite the removable seal.

Returning to FIG. 3, removable seal 18 covers an area that preferably includes an oxygen diffuser 22 (see, FIG. 3) which controls the rate at which oxygen enters heater 10 (and subsequently reacts with the chemicals of heater substrate 12). It is contemplated that pad 14 could be used as oxygen diffuser 22 and could be used to control oxygen access to heater 10. See, FIG. 1. Further, such use of pad 14 can assist in distributing oxygen by allowing for various pathways for the oxygen to diffuse. Oxygen diffuser 22 may be secured to package 16 or it may be unsecured to package 16 and is preferably disposed between pad 14 and seal 18.

In addition to possibly being used as oxygen diffuser, pad 14 could also be used to provide further structural integrity to heater substrate 12 (and package 16). This would allow for thinner packages, resulting in lower cost and lower heat loss.

Unlike some methods wherein the heater is produced in different stages, or produced in an inert (i.e., oxygen-free) environment, it has been determined that the use of pad 14 allows for a method of producing a complete heater in the presence of atmospheric oxygen. Pad 14, when impregnated with electrolyte and positioned in contact with heater, will act as a barrier to oxygen in the atmosphere reaching the surface of the heater (where the reducing agent and electrolyte are present). It is believed that methods of manufacturing according to the present invention allow for a heater that can be exposed to oxygen for up to 60 seconds (or possibly longer depending on internal standards) without producing too much heat.

One method of producing a heater according to the present invention includes the following steps: providing a pad; applying an electrolyte solution to the pad; allowing the pad to absorb the electrolyte solution; placing a heater next to the pad; and, sealing the heater and pad in a package.

Another method of producing a heater includes the following steps (preferably in the following order): providing a heater substrate; placing a pad material on at least a first side of the heater substrate; applying an electrolyte to the pad; and sealing the heater in a package, wherein the steps of the method occur in an oxygen containing atmosphere. As previously mentioned, with the use of the pad to absorb and transfer the electrolyte to the heater substrate, the pad functions as an oxygen barrier to minimize the amount of oxygen that reaches the heater substrate during assembly—allowing the manufacturing to be performed in an oxygen rich environment.

It is preferred that the step of applying the electrolyte to the pad is performed with a manifold which may be connected to metered volumetric pumps. This can allow for a predetermined and consistent amount of electrolyte to be applied. Additionally, this can allow for electrolyte to be added only to predetermined and specific points of the pad—while the pad will, generally, evenly transfer the electrolyte to the heater substrate without pooling or beading up.

It is also preferred that pad have the same size dimensions (length and width) as heater substrate. Accordingly, it may be needed to cut pad to match size of heater. However, it is contemplated that pad is differently sized than heater.

It is contemplated that the heater substrate is first placed on a first sheet which is used as a carrier in the manufacturing process, and which also will be a layer of package for the heater. Moreover, heater may be heat bonded to first sheet.

The methods may also include the step of providing an air diffuser next to the heater.

In addition, a removable seal can be provided and, for example, sealed to the package. In particular, a portion of the removable seal can be heat sealed to package allowing it to be opened and subsequently closed without fully removing it from package.

In some embodiments, heater is placed on a carrier during production for ease of transport, and carrier may be a layer for package. This will allow a simple production of package with a second layer on top of heater (and pad) after electrolyte has been added. It is preferred that carrier be larger (width and length) so that carrier and second (or outer layer) can directly contact and be sealed (for example heat bonded) to allow for the creation of the package.

In an alternative embodiment, during production and processing of heater substrate 12, material of heater substrate 12 is placed on a carrier which is pad 14. Since the material is a paste like substance, the material can be poured onto pad. After spreading (PJS comment: how do you get the paste to cover the entire surface of pad?) the material over the top surface of pad 14, pad and material enter an oven to process the material and remove water. As discussed above, in this type of manufacturing process (at a temperature of approximately 400° F.), it has been found that a mixture of cellulose and cotton does not deform and thus is more desirable than a mixture of cellulose and polyester. However, it will be appreciated that if a lower temperature is used, the mixture of cellulose and polyester may be acceptable for use in this type of manufacturing processes.

After material has been processed, the resulting heater 100, shown in FIG. 5, heater substrate 102 and pad 104 will have become intermeshed meaning that pad 104 cannot be removed from heater substrate without damaging pad 104 and heater substrate 102. Since pad 104 is porous and material of heater substrate 102 is flowable at the time it is disposed onto pad 104, material will flow into some of the apertures in pad 104.

Thus, as shown heater 100 has three zones, substrate zone 110, mixed zone 112, and pad zone 114. As can be seen, substrate zone 110 is comprised substantially exclusively of heater substrate 102 and likewise pad zone 114 is comprised substantially exclusively of pad 104. Intermeshed zone 114 is comprised of a mixture of substrate 102 and pad 104 in which substrate 102 and pad 104 are intermeshed.

Subsequently, the heater substrate 12 and pad 14 combination can be flipped over, may be placed on a carrier which is also a layer of package, and the combination may proceed through the manufacturing steps discussed above.

Beyond the benefits already discussed, it is believed that a manufacturing process including applying the electrolyte to the pad can be done faster than applying the electrolyte to the heater. This, in turn, will allow for faster production times, and thus, lower production costs.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A heater comprising:
a substrate comprising a reducing agent that produces heat in the presence of oxygen and a binding agent;
a pad disposed adjacent and in contact with the substrate and including an electrolyte solution, wherein the pad is capable of transferring the electrolyte solution to the substrate; and,
a package surrounding the substrate and the pad.

2. The heater of claim 1 wherein the package includes a removable seal, and the seal is capable of being re-attached after removal.

3. The heater of claim 1 wherein the pad comprises a blend of cellulose and cotton.

4. The heater of claim 1 wherein the pad comprises a blend of cellulose and polyester.

5. The heater of claim 1 wherein the pad comprises a synthetic nonwoven material.

6. The heater of claim 1 wherein the substrate and the pad are intermeshed.

7. The heater of claim 1, the heater further comprising:
a substrate zone comprised of substantially exclusively substrate;
a pad zone comprised of substantially exclusively pad; and,
a mixture zone comprised of a mixture of pad and substrate.

8. A method of making a heater comprising the steps of:
providing a substrate which includes a reducing agent that produces heat in the presence of oxygen and a binding agent;
placing a pad on at least a first side of the substrate and in contact with same,
applying an electrolyte solution to the pad; and,
sealing the substrate and pad in a package, wherein at least the step of applying the electrolyte solution to the pad occurs in an oxygen containing environment.

9. The method of claim 7 wherein the electrolyte solution is applied to the pad with a manifold.

10. The method of claim 9 wherein the manifold is connected to at least one volumetric pump.

11. The method of claim 9 wherein the time between the steps of applying the electrolyte and sealing the substrate and pad in a package takes no more than 60 seconds.

12. The method of claim 8 wherein a plurality of heaters are made, and a substantially identical amount of electrolyte is applied for each heater.

13. The method of claim 12 wherein, the electrolyte is applied at substantially identical positions on each heater.

14. The method of claim 8 wherein the substrate is provided on top of a carrier, and the carrier is a first side of package.

15. The method of claim 14 wherein the step of sealing the substrate and pad in a package comprises the steps of:
applying an outer layer on top of the pad and the heater, such that a portion of outer layer directly contacts a portion of carrier layer;
sealing carrier layer to outer layer.

16. The method of claim 15 wherein outer layer includes a removable seal.

17. The method of claim 16 wherein an oxygen diffuser is disposed between the outer layer and the pad.

18. The method of claim 17 wherein the oxygen diffuser is secured to the outer layer.

19. The method of claim 17 wherein the oxygen diffuser is unsecured to the outer layer.

20. A method of making a heater comprising the steps of:
mixing a reducing agent that produces heat in the presence of oxygen and a binding agent to produce a mixture;
pouring the mixture onto a first side of a pad;
heating the mixture on the first side of the pad in an oven; and,
applying an electrolyte solution to the pad after the heating step.
